(19) United States
(12) Patent Application Publication
(10) Pub. No.: US 2005/0112388 A1
(43) Pub. Date: May 26, 2005

(54) Coated metal plate

(76) Inventors: Tadashi Watanabe, Hiratsuka-shi (JP); Tadayoshi Hiraki, Odawara-shi (JP); Akira Tominaga, Chigasaki-shi (JP); Takeshi Yawata, Hiratsuka-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/979,263

(22) Filed: Nov. 3, 2004

Related U.S. Application Data
(63) Continuation of application No. 09/466,724, filed on Dec. 17, 1999.

(30) Foreign Application Priority Data
Dec. 17, 1998 (JP) 359,021/98

(51) Int. Cl. B32B 15/04; B05D 7/00

(52) U.S. Cl. 428/457; 428/458; 428/336; 427/402

(57) ABSTRACT

According to the present invention, provided is a coated metal plate characterized by comprising a metal plate and laminated at least on one surface of a metal plate, a conductive plastic coated film and an electrodeposition coated film, which is useful as an outer plate part for car bodies and electrical appliances.

### BACKGROUND OF THE INVENTION

1. Field of the Invention

The present invention relates to a metal plate comprising a conductive plastic coated film and an electrodeposition coated film which are laminated and coated at least on one surface thereof, which is particularly useful as an outer plate part for car bodies and electrical appliances.

2. Description of the Related Art

It is widely carried out to apply electrodeposition paint as a primer on a metal plate and then apply intermediate paint and topcoat paint to form a composite coated film, but there is the defect that if an impact given by allowing small stone to strike is exerted on this composite coated film, a coated film at a part thereof is liable to be locally peeled off. Further, at least three kinds of paints have to be applied in order to form this composite coated film, and labor saving at these coating steps and a reduction in carbon dioxide are strongly requested.

### SUMMARY OF THE INVENTION

Investigations repeated by the present inventors in order to solve such problems as described above in a metal plate coated with a composite coated film have resulted in finding that the problems described above can be solved at a stroke by laminating and coating a conductive plastic coated film and an electrodeposition coated film on a metal plate, and they have come to complete the present invention.

Thus, according to the present invention, provided is a coated metal plate characterized by comprising a conductive plastic coated film and an electrodeposition coated film which are laminated at least on one surface of a metal plate.

The coated metal plate of the present invention shall be explained below in detail.

### DESCRIPTION OF SPECIFIC EMBODIMENTS

A metal plate used for preparing the coated metal plate of the present invention includes, for example, metal plates of iron, steel, stainless steel, aluminum, copper and alloys containing these metals, and metal plates obtained by plating the surfaces thereof with zinc, zinc/nickel and aluminum, and they can be used in the form of a coil or a cut plate. The metal plates have suitably a thickness falling in a range of usually 0.3 to 2.0 mm, particularly 0.5 to 1.0 mm. The surfaces of these metal plates are preferably subjected in advance to suitable preliminary treatment such as polishing treatment, degreasing treatment and phosphate treatment in order to elevate an adhesive property with a plastic layer and an anticorrosive property.

Plastics used for coating these metal plates shall not specifically be restricted, and there can be used, for example, known optional thermoplastic resins including polyolefin resins such as polyethylene and polypropylene, polyester resins such as polyethylene terephthalate (PET), polycarbonate resins, epoxy resins, vinyl acetate resins, vinyl chloride resins, fluorine-containing resins, polyvinyl acetal resins, polyvinyl alcohol resins, polyamide resins such as nylon, polyphenylene oxide, acetal resins, ABS resins, polystyrene resins, acryl resins, polyurethane resins, phenol resins, polyether resins, polyetherimide resins, and fiber base resins. These resins can suitably be blended with color pigments and extender pigments.

The metal plate can be coated with the plastic film by known methods. It can be coated, for example, by such methods that a film-shaped or sheet-shaped plastic molded by extrusion molding, injection molding, calendar molding and compression molding is adhered on a metal plate; a plastic molten by heating is extruded into a film or sheet, and it is adhered on a metal plate by pressing; and a solution or a dispersion of the resins described above is coated on a metal plate. The plastic film is coated on the surface of the metal plate positioned at least on the outside of a product for which the coated metal plate is used and can be coated, if desired, on both surfaces including a back surface.

The plastic coated films thus formed on the metal plate have a thickness falling suitably in a range of usually 1 to 100 μm, particularly 3 to 75 μm and more particularly 5 to 50 μm. Further, these plastic films can be subjected on the surfaces thereof to treatment such as corona discharge treatment, plasma treatment and flame treatment before or after coated on the metal plate.

In sticking a film-shaped or sheet-shaped plastic on the metal plate to coat the metal plate with the plastic, an adhesive is preferably applied in advance on the surface of the metal plate and/or the plastic film or sheet in order to enhance an adhesive property between both. Such adhesive includes, for example, thermosetting or thermoplastic adhesives containing at least one resin selected from bisphenol type epoxy resins, resol type epoxy resins, acryl resins, aminoplast resins, polyester resins, urethane resins and polysiloxane resins and, if necessary, a curing agent. Further, there can also be used as the adhesive, triazinethiol base compounds such as 2,4,6-trimercapto-s-triazine, 2-dibutylamino-4,6-dimercapto-s-triazine, 2,4,6-trimercapto-s-triazine monosodium salt and 2,4,6-trimercapto-s-triazine trisodium salt.

In the present invention, this plastic coated film has to be provided with a conductivity, and to be specific, it can be provided by such a method as (a) dispersing and incorporating a conductive substance into the inside of the plastic coated film or (b) forming a film of a conductive substance on the surface of the plastic coated film.

In the method (a) described above, the conductive substance which can be dispersed and incorporated into the inside of the plastic coated film includes, for example, palladium, copper, aluminum, iron, nickel, carbon black, carbon fiber and graphite, and the plastic film can be provided with a conductivity by mixing and dispersing a powder of at least one conductive substance selected from them into the plastics described above. The powder of these conductive substances can have an average particle diameter falling in a range of usually 0.1 to 10 μm, preferably 0.1 to 5 μm. The conductive substance in the inside of the plastic coated film can have such content that the resulting conductive plastic film has a volume specific resistance value of 10³ Ω·cm or less, preferably 10² Ω·cm or less and more preferably 50 Ω·cm or less, wherein the volume specific resistance value is determined according to JIS K6911-1955.

In the method (b) described above, a continuous film of a conductive substance is formed on the surface of the plastic coated film to form a conductive layer. To be specific, a continuous film of a conductive metal such as gold (Au), palladium (Pd) and aluminum (Al) or a semiconductor such as metal oxides of indium (In), titanium (Ti), cadmium and tin and copper iodide can be formed on the surface of the plastic coated film by a method such as vacuum deposition, spattering, spray and electroless plating. This conductive film has a film thickness falling preferably in a range of usually 1 μm or less, particularly 0.1 to 0.01 μm. The conductive plastic film obtained by this method has a surface resistance value of 100 Ω/□ or less, particularly 50 Ω/□ or less and more particularly 10 Ω/□ or less. In this method (b), the plastic film itself on which the conductive layer is formed may be either non-conductive or conductive. The surface resistance value is determined according to JIS K6911-1955.

The plastic coated film is coated on one surface or both surfaces of the metal plate. The plastic coated film can be provided with a conductivity on one surface thereof in the former case and on either one or both surfaces of the plastic coated films laminated on both surfaces of the metal plate in the latter case. In the present invention, the plastic coated film surface provided with a conductivity is preferably disposed oppositely to the surface of a product for which this is intended to be used.

The coated metal plate of the present invention can be produced by laminating an electrodeposition coated film on the surface of the above conductive plastic coated film of the metal plate (hereinafter called “conductive coated metal plate”) coated with the conductive plastic coated films in the manner described above. To be specific, the conductive coated metal plate is cut to an intended shape and size, molded and, if necessary, joined to prepare a molded article having an intended form, and then the surface of the conductive plastic coated film in the above molded article is coated by electrodeposition.

The coated metal plate provided by the present invention in which the conductive plastic coated film and the deposition coated film are laminated at least on one surface of the metal plate is preferably applied particularly to the outer plate parts of car bodies and electric appliances.

Specific examples in the case where it is applied to the outer plate parts of car bodies include a method in which the conductive coated metal plate is cut, molded and, if necessary, joined to form a shell body for a car body and then a conductive plastic-coated face, a cut end face and a metal-exposed part in this shell body are coated by electrodeposition coating to obtain a car body (hereinafter called a method A); and a method in which the conductive coated metal plate is cut, molded and, if necessary, joined to form a car part and then this part is mounted on a main body of an automobile which has been assembled in advance to prepare a shell body, followed by coating a conductive plastic-coated face, a cut end face and a metal-exposed part in this shell body by deposition coating to obtain a car body (hereinafter called a method B).

In the method A described above, the conductive coated metal plate produced in the manner described above is cut, molded and joined to assemble a shell body. To be specific, the conductive coated metal plate is used to produce the respective parts for a main body and an outer covered part, and then they are combined to form a shell body.

This shell body is a part to which equipments such as an engine and a chassis are not installed and which is composed mainly of sheet metal. Among them, the main body is composed mainly of parts such as an underbody, a side member, a roof, a cowl, an upper back and a lower back. An outer covered part other than them is composed mainly of parts such as a hood, a front balance, a front fender, a cowl louver, doors and a luggage (back doors), and the respective parts in the outer covered part are called automobile parts.

The underbody means floor parts such as a passenger compartment (cabin) and a luggage boot and is a general term for a front underbody, a front floor and a rear floor. The side member is to combine with a front body, a roof panel and an underbody to form a side face of a cabin and prevent bending and torsion of the vehicle. The cowl is a panel for connecting longitudinal and lateral pillars. The upper back is a panel for connecting right and left quarter panels (rear fenders) at a rear part of a car body to form an outside face of the car body.

In the method A described above, in order to form the respective parts described above for constituting a shell body, the conductive coated metal plate produced in such manner as described above is cut to an intended shape and size and molded by pressing by means of a press working machine and, if necessary, they are joined by adhering with an adhesive, welding and bolting to produce respective parts for a main body such as an underbody, a side member, a roof, a cowl, an upper back and a lower back, and respective parts (automobile parts) for an outer covered part such as a hood, a front balance, a front fender, a cowl louver, doors and a luggage. They can be cut, molded and joined by known methods. Next, the respective parts for the main body which have been formed in the manner described above using the conductive coated metal plate are combined and joined to form the main body, and then the respective parts (automobile parts) for the outer covered part such as a hood, a front balance, a front fender, a cowl louver, doors and a luggage are mounted thereon.

The shell body which has been assembled in the manner described above using the conductive coated metal plate is coated at least on an outside thereof with the plastic layer. An end face of the cut plastic-coated metal plate is exposed at a metal part. Further, a back side thereof is preferably coated with the plastic, but the metal part is exposed in a certain case. In the method A described above, these metal-exposed parts can be the subjected to electrodeposition coating.

On the other hand, in the method B described above, the conductive coated metal plate produced in the manner described above is used, and it is cut, molded and joined to produce the respective parts (automobile parts) for the outer covered part such as a hood, a front balance, a front fender, a cowl louver, doors and a luggage. These automobile parts are mounted on the main body of a car body which has been assembled in advance to form a shell body. Among them, the respective parts (automobile parts) for the outer covered part for which the conductive coated metal plate is used can be produced in the same manner as in the method A.

In the method B described above, a great part or all of the automobile parts constituting the outer covered part are produced using the plastic-coated metal plate described above. For example, in order to form the respective parts such as a hood, a front balance, a front fender, a cowl louver, doors and a luggage (back doors) which constitute the outer covered part, the plastic-coated metal plate is cut to an intended shape and size and molded by pressing by means of a press working machine and, if necessary, they are jointed by adhering with an adhesive, welding and bolting to produce the respective parts (automobile parts) such as a hood, a front balance and the like. These cutting, molding and joining can be carried out by known methods. The respective parts (automobile parts) for the outer covered part which are molded in the manner described above are coated at least on the outsides thereof with the plastic layers, and the end faces of the cut steel sheets are exposed at metal parts. Further, the back sides thereof may be exposed at metal parts without being coated or coated with the plastic.

In the method B described above, the main body which is composed of an underbody, a side member, a roof, a cowl, an upper back and a lower back and on which these automobile parts are mounted is produced usually by cutting, molding and working a non-coated metal plate without using a conductive coated metal and joining them by known methods. The respective parts (automobile parts) for the outer covered part which are produced using the conductive coated metal plate are mounted on the main body produced using such non-coated metal plate to prepare a shell body. In the method B described above, the whole surface of the main body in the shell body which has been assembled in the manner described above and the metal-exposed parts of the the outer covered part (automobile parts) can be subjected to electrodeposition coating.

The electrodeposition paint used for obtaining the coated metal plate of the present invention may be either an anionic type or a cationic type. In general, cationic type electrodeposition paint capable of forming a coated film having an excellent corrosion resistance is preferably used.

In the present invention, an electrodeposition coated film is formed on the surface and the metal-exposed part of the conductive plastic coated film of the coated metal plate, and therefore preferably used is cationic electrodeposition paint having functions of an intermediate paint film such as a flatness, a ground covering property (covering fine irregularities on a coated surface to finish it to the flat surface) and a weatherability in addition to functions of a conventional undercoated film (for example, a corrosion resistance, an adhesive property and a chipping resistance).

The cationic electrodeposition paint having both of such functions includes paints containing as a base resin, base resins having a hydroxyl group and an amino group which can be converted to cation: for example, (i) cationic electrodeposition paints containing polyester resins, acryl resins and polyurethane resins each having a hydroxyl group and an amino group (see U.S. Pat. No. 5,483,012); (ii) cationic electrodeposition paints containing amino group-containing epoxy resins which are modified by base resins such as polyester resins, acryl resins and polyurethane resins each having a hydroxyl group and an amino group (see U.S. Pat. No. 5,739,185); and (iii) cationic electrodeposition paints containing as base resins, mixtures of nonionic resins such as polyester resins, acryl resins, modified polyolefin resins and polyurethane resins with hydroxyl group and amino group-containing epoxy resins (see U.S. Pat. Nos. 5,739,185 and 4,916,019; Japanese Laid-Open Pat. Publication No. 292295/ 1995). These resins have preferably a number average molecular weight falling in a range of usually 400 to 10000, particularly 1000 to 4000. An amino group can be introduced into the resins, for example, by reacting resins having a functional group (for example, an epoxy group) capable of reacting with an amino group with primary or polyamines or secondary or polyamines, or using amino group-containing polymerizable monomers in producing the resins. The base resins thus obtained have an amine value falling preferably in a range of usually 3 to 200 mg/KOH, particularly 10 to 80 mg/KOH and a hydroxyl value falling preferably in a range of usually 10 to 200 mg/KOH, particularly 30 to 150 mg/KOH.

These cationic electrodeposition paints may be either an external cross-linking type using a curing agent in combination or an internal (self) cross-linking type in which a cross-linking functional group is coexistent in a base resin. The curing agent used in the form of an external cross-linking type includes, for example, block polyisocyanate compounds capable of reacting with a hydroxyl group and/or a primary or secondary amino group, amino resins and tri-(alkoxycarbonyl) triazines (common name: TACT). Among them, aliphatic block polyisocyanate compounds are particularly suited. Also, the cross-linking functional group of an internal (self) cross-linking type includes suitably, for example, a block isocyanate group and an β,β-unsaturated carbonyl group.

In the aliphatic block polyisocyanate compounds described above, substantially all isocyanate groups of the aliphatic polyisocyanate compounds are blocked with a volatile blocking agent, and if they are heated to a prescribed temperature or higher, this blocking agent is dissociated to regenerate the isocyanate groups, and they take part in a cross linking reaction with a base resin.

The aliphatic polyisocyanate compounds have two or more free isocyanate groups in a molecule and include, for example, aliphatic diisocyanates such as hexamethylenediisocyanate, trimethylenediisocyanate, tetramethylenediisocyanate, dimer acid diisocyanate and lysine diusocyanate; and alicyclic diisocyanates such as isophoronediisocyanate, methylenebis(cyclohexylisocyanate), methylcyclohexanediisocyanate, cyclohexanediisocyanate and cyclopentanediisocyanate.

Further, the blocking agent which can be used for blocking the free isocyanate groups of these polyisocyanate compounds includes known blocking agents of a phenol base, an alcohol base, an active methylene base, a mercaptan base, an acid amide base, an imide base, an amine base, an imidazole base, a urea base, a carbamic acid base, an imine base, an oxime base, a sulfurous acid base and a lactam base.

A structural proportion of the base resin to the block polyisocyanate compound is 40 to 90 %, particularly 50 to 80 % for the former and 60 to 10 %, particularly 50 to 20 % for the latter each based on the total solid weight of both components.

The cationic electrodeposition paint can be prepared by blending the base resin, if necessary, with the curing agent such as a block polyisocyanate compound, then neutralizing a cationic group such as an amino group contained in the base resin with an acid compound such as acetic acid, formic acid, lactic acid, phosphoric acid and amidosulfonic acid and mixing with water. The pH in coating is controlled preferably in a range of usually 3 to 9, particularly 5 to 7, and the solid concentration is controlled preferably in a range of usually 5 to 30 % by weight.

The cationic electrodeposition paint can suitably be compounded, if necessary, with a curing catalyst having a corrosion resistance such as hydroxides, oxides, organic acid salts and inorganic acid salts of metals selected from, for example, aluminum, nickel, zinc, strontium, lead, zirconium, molybdenum, tin, antimony, lanthanum, tungsten and bismuth; rust preventive pigments, color pigments usually used as an inhibitor, organic pigments, extender pigments and precipitation preventive.

The conductive coated metal plate is worked into an intended shape, molded, joined and then dipped in a cationic electro-deposition paint bath to be coated by electrodeposition at a bath temperature of 20 to 35° C., a voltage of 100 to 400 V and a current flow time of 1 to 10 minutes with this plate used as a cathode, whereby electrodeposition coated films can be deposited on the surface of the conductive plastic film, the metal-exposed parts of the end faces brought about by cutting and the metal parts which are not coated with the plastics. These deposited electrodeposition coated films have a film thickness falling preferably in a range of usually about 10 to about 40 μm, particularly 10 to 20 μm in terms of a cured coated film thickness. After coating, the metal plate is drawn up from the paint bath, suitably washed with water and then heated at 100 to 200 ° C. to cure electrodeposition coated films, whereby the coated metal plate intended by the present invention can be obtained.

In the coated metal plate which is coated by electrodeposition obtained according to the present invention, the electrodeposition coated film has a function as an intermediate coated film, so that intermediate coating which has so far been carried out can be omitted and topcoat paint can be applied directly on the electrodeposition coated film surface, but conventional intermediate paint may be coated.

According to the coated metal plate of the present invention described above, effects described below can be obtained.

(1) The metal plate is coated directly with the plastic and therefore improved notably in a chipping resistance as compared with that of a composite coated film produced by electrodeposition coating-intermediate coating-top coating.

(2) Intermediate coating can be omitted, so that the coating steps can be shortened and the amount of VOC (volatile organic compounds) can be reduced to a large extent.

(3) The electrodeposition coated film which is coated on a plastic-coated surface has an excellent flatness, and therefore the surface of a top coated film formed thereon is improved as well in a flatness and a distinctness-of-image gloss.

### EXAMPLES

The present invention shall more specifically be explained below with reference to examples and comparative examples. Both parts and percentage are based on weight, and the film thickness of a coated film is that of a cured coated film.

1. Production of Conductive Coated Metal Plate

(a) Used was a biaxial oriented polyester film (thickness: 16 μm) in which indium tin oxide (ITO) and palladium (Pd) were deposited on one surface thereof by spattering, and a non-deposited surface thereof was subjected to corona discharge treatment. Then, a thermosetting polyester resin base adhesive was applied on this surface subjected to corona discharge treatment to a film thickness of 7 μm and heated at 120° C. for 30 seconds. The deposited surface of the conductive film thus obtained had a surface resistance value of 10 Ω/□.

Then, an alloyed molten zinc-plated steel sheet having a thickness of 0.8 mm and a plated deposition amount of 45 glm ² was subjected to degreasing and zinc phosphate treatment (trade name: “PB #3080” manufactured by Nihon Parkerizing Company). The conductive film described above was stuck on one face of this steel sheet so that the adhesive layer of the conductive film contacted it and coated thereon by heat-pressing “conductive coated metal plate (a)”.

(b) Used was a conductive polyester film with a thickness of 20 μm containing 30 % of furnace carbon black (conductive sub-stance), and both faces thereof were subjected to corona discharge treatment. Then, a thermosetting polyester resin base adhesive containing 20 % of furnace carbon black was applied on one surface thereof to a film thickness of 7 μm and heated at 120° C. for 30 seconds. The conductive film thus obtained had a volume specific resistance value of 30 Ω·cm.

Then, an alloyed molten zinc-plated steel sheet having a thickness of 0.8 mm and a plated deposition amount of 45 g/m ² was subjected to degreasing and zinc phosphate treatment (trade name: “PB #3080” manufactured by Nihon Parkerizing Company). The conductive film described above was stuck on one face of this steel sheet so that the adhesive layer of the conductive film contacted it and coated thereon by heat-pressing “conductive coated metal plate (b)”.

2. Examples and Comparative Examples

### Example 1

The conductive coated metal plate (a) which was cut to a size of 15 cm ×10 cm was dipped in a bath of a cationic electrodeposition paint (remark 1) and coated by electrodeposition on the conditions of a bath temperature of 28° C., a voltage of 250 V and a current flow time of 3 minutes with a metal-exposed part thereof used as a cathode, and then after drawing up from the bath and washing with water, it was heated at 170° C. for 30 minutes to cure electrodeposition coated films. Formed were an electrodeposition coated film of 20 μm on the surface of the conductive film of the metal plate (a) thus coated by electrodeposition, an electrodeposition coated film of 10 μm on the metal part of the end face and an electrodeposition coated film of 25 μm on the metal-exposed face of the back face.

Cationic electrodeposition paint (remark 1):

A flask equipped with a stirrer, a thermometer, a nitrogen introducing tube and a reflux condenser was charged with 666 g of isophoronedilsocyanate (manufactured by DAICEL-Hülls Co., Ltd.), 269 g of methyl isobutyl ketone, 118 g of ethylene glycol monobutyl butyl ether and 0.2 part of dibutyl tin dilaurate, and they were reacted at 70° C. under a nitrogen atmosphere until the concentration of an isocyanate group became 6.38 millimole/g. Then, 1634 g of Praxel 208 (OH equivalent: 409, manufactured by DAICEL CHEMICAL INDUSTRIES, LTD.) which was cyclic lactone ring-opened polyesterpolyol and reacted at 70° C. under nitrogen atmosphere until the concentration of an isocyanate group became 0.414 millimole/g to obtain a viscous urethane prepolymer.

Then, a flask equipped with a stirrer, a thermometer, a nitrogen-introducing tube and a reflux condenser was charged with 775 g of bisphenol A diglycidyl ether having an epoxy equivalent of 190, 237 g of bisphenol A and 13.5 g of methylbenzylamine, and they were reacted at 110° C. until the epoxy concentration became 1.85 millimole/g to obtain an epoxy resin (a number average molecular weight: 1025 and an epoxy equivalent: 539). Added to this epoxy resin was 1333 g of the urethane prepolymer solution described above, and they were reacted at 90° C. until the isocyanate group was not detected. Then, the solution was diluted with 378 g of ethylene glycol monobutyl ether, and 200 g of diethanolamine was added and reacted at 90° C. until the epoxy group was not detected. Then, the solution was diluted with ethylene glycol monobutyl ether to a solid content of 75 % to obtain a polyurethane-modified amine-added epoxy resin having a primary hydroxyl group equivalent of 638 and an amine value of 46.3.

On the other hand, 26 parts of butyl cellosolve was heated to 130° C., and 37.5 parts of a 80 % polyester monomer (trade name: “FM-3X”, manufactured by DAICEL CHEMICAL INDUSTRIES, LTD.), 40 parts of styrene, 25 parts of hydroxyethyl methacrylate, 5 parts of n-butyl methacrylate and 4 parts of AIBN (azobisisobutyronitrile) were dropwise added thereto at the same temperature in 5 hours. Then, the solution was maintained at 130° C. for 2 hours, and 5 parts of butyl cellosolve and 0.5 part of azobisdimethylvaleronitrile were dropwise added thereto at 130° C. in 2 hours. Further, the solution was maintained at 130° C. for 2 hours, and then 23 parts of cellosolve was added, followed by cooling down, whereby an acryl base resin solution having a solid content of 62 % and a number average molecular weight of about 5000 was obtained.

Mixed were 67 parts (solid) of the polyurethane-modified amine-added epoxy resin described above, 8 parts (solid) of the acryl base resin solution and 25 parts (solid) of methyl ethyl ketone oxime block isophoronediusocyanate, and further added thereto were 1 g of polypropylene glycol (SANIX PP4000 manufactured by SANYO CHEMICAL INDUSTRIES, LTD.), 0.82 g of formic acid and 1 g of lead acetate each per 100 g of the resin solid. The solution was heated up to 40° C., and deionized water was slowly added thereto while stirring to prepare an aqueous dispersion, whereby a stable emulsion having a resin solid content of 30 % was obtained. Added were 3 g of basic lead silicate, 13 g of titanium white, 0.3 g of carbon, 3 g of clay, 2 g of dibutyl tin oxide and 1 g of a nonionic surfactant (trade name: “Noigen EA-142B” manufactured by DAI-ICHI KOGYO SEIYAKU CO., LTD.) each per 100 g of the resin solid of the emulsion thus obtained. The pigment was dispersed by means of a ball mill until the particle size thereof became 10 micron or less, and then the emulsion was further diluted with deionized water to a resin solid content of 15 % to obtain a cationic electrodeposition paint.

### Example 2

The conductive coated metal plate (b) having a thickness of 0.8 mm which was cut to a size of 15 cm×10 cm was dipped in a bath of the same cationic electrodeposition paint as in Example 1 and coated by electrodeposition on the conditions of a bath temperature of 28° C., a voltage of 250 V and a current flow time of 3 minutes with a metal-exposed part thereof used as a cathode, and then after drawing up from the bath and washing with water, it was heated at 170° C. for 30 minutes to cure electrodeposition paint films. Formed were an electrodeposition coated film of 20 μm on the surface of the conductive film of the metal plate (b) thus coated by electrodeposition, an electrodeposition coated film of 10 Mm on the metal part of the end face and an electrodeposition coated film of 25 μm on the metal-exposed face of the back face.

### Example 3

The conductive coated metal plate (a) having a thickness of 0.8 mm which was cut to a size of 15 cm×10 cm was dipped in a bath of the same cationic electrodeposition paint as in Example 1 and coated by electrodeposition on the conditions of a bath temperature of 28° C., a voltage of 300 V and a current flow time of 3 minutes with a metal-exposed part thereof used as a cathode, and then after drawing up from the bath and washing with water, it was heated at 170° C. for 30 minutes to cure electrodeposition coated films. Formed were an electrodeposition coated film of 35 μm on the surface of the conductive film of the metal plate (a) thus coated by electrodeposition, an electrodeposition coated film of 15 μm on the metal part of the end face and an electrodeposition coated film of 40 μm on the metal-exposed face of the back face.

### Example 4

A non-coated metal plate having a thickness of 0.8 mm was cut, molded and joined to prepare in advance a model (about one-twenty fifth as large as the actual article in size) of a main body comprising an underbody, a side member, a roof, a cowl, an upper back and a lower back. On the other hand, the conductive coated metal plate (a) was cut, molded and joined to prepare models (about one-twenty fifth as large as the actual articles in size) of outer covered parts (automobile parts) such as hoods, fenders, doors and luggage doors.

These outer covered parts were mounted on the main body described above to form a shell body, and this was dipped in a bath of the same cationic electrodeposition paint as in Example 1 and coated by electrodeposition on the conditions of a bath temperature of 28° C., a voltage of 250 V and a current flow time of 3 minutes, and then after washing with water, it was heated at 170° C. for 30 minutes to cure electrodeposition coated films. Formed were an electrodeposition coated film of 20 μm on the surface of the conductive film of the shell body thus coated by electrodeposition, an electrodeposition coated film of 10 μm on the metal part of the end face and an electrodeposition coated film of 25 μm on the metal-exposed face of the back face.

### Example 5

The same operation as in Example 4 was carried out, except that the conductive coated metal plate (a) used in Example 4 was changed to the conductive coated metal plate (b).

### Comparative Example 1

Electrodeposition coating was carried out in the same manner as in Example 1, except that the conductive coated metal plate (a) used in Example 1 described above was changed to a non-coated metal plate which was subjected to alloyed molten zinc plating so that the plated deposition amount became 45 g/m ² and then to degreasing treatment and zinc phosphate chemical conversion treatment (“PB #3080 treatment”).

### Comparative Example 2

The conductive coated metal plate (b) which was cut to a size of 15 cm×10 cm.

3. Performance Test Results

The electrodeposition coated articles obtained in the examples and the comparative examples were subjected to the performance tests. The results thereof are shown in Table 1.

TABLE 1

| | | | | | | Comparative | |
|---|---|---|---|---|---|---|---|
| | Example | | | | | Example | |
| | 1 | 2 | 3 | 4 | 5 | 1 | 2 |
| Chipping resistance | ◯ | ◯ | ◯ | — | — | X | Δ |
| Corrosion resistance for | ◯ | ◯ | ◯ | ◯ | ◯ | Δ | Δ |
| general parts | | | | | | | |
| Corrosion resistance for edges | ◯ | ◯ | ◯ | ◯ | ◯ | Δ | X |
| Clarity | 85 | 85 | 90 | 85 | 85 | 50 | 60 |
| Weatherability | 700< | 700< | 700< | 700< | 700< | 700< | 400 |

The test methods are as follows:

Chipping Resistance:

A white topcoat paint (trade name: “AMILAC WHITE” manufactured by Kansai Paint Co., Ltd., polyester resin·melamine resin base) was applied to a film thickness of 35 μm on the coated metal plates obtained after electrodeposition coating—curing by heating in Examples 1 to 3 and Comparative Examples 1 to 2 and cured by heating at 140° C. for 30 minutes. The coated plates thus obtained were tested.

A tester (trade name: “Q-G-R Gravelo Meter” manufactured by Q Panel Co., Ltd.) was used, wherein 50 g of No. 7 crushed stones was blown onto the coated surfaces at an air pressure of about 4 kg/cm² and an angle of 90 degree at −20° C.; then, an adhesive cellophane tapes were stuck on the coated surfaces, and they were quickly peeled off, and then, the state of the coated films peeled off from the impacted parts was visually observed. A mark ◯ shows that a little peeling of the top coated film caused by impact is observed but no exposure on the metal face is found; a mark Δ shows that a lot of peeling of the top coated film caused by impact is observed and a little exposure on the metal face is found as well; and a mark × shows that a lot of peeling of the top coated film caused by impact is observed and a lot of exposure on the metal face is found as well.

Corrosion Resistance for General Parts:

The coated articles obtained in Examples 1 to 5 and Comparative Examples 1 to 2 were stored in a brine-resistance spray tester (35° C.) for 960 hours, and then visually observed were the corrosion resistances at the conductive film-adhered parts (examples) of the coated articles and the electrodeposition coated parts (comparative examples). A mark ◯ shows that no rust and blister are observed to be produced; a mark Δ shows that a little rust and blister are observed to be produced; and a mark × shows that a lot of rust and blister are observed to be produced.

Corrosion resistance for edges:

The coated articles obtained in Examples 1 to 5 and Comparative Examples 1 to 2 were stored in the brine-resistance spray tester for 240 hours, and then visually observed were the corrosion resistances at the end parts (acute angle parts) of the cut parts in the metal plates. A mark ◯ shows that no rust is observed to be produced at the end part; a mark Δ shows that a little rust is observed to be produced at the end part; and a mark × shows that a lot of rust is observed to be produced at the end part.

Clarity:

An image clarity measuring apparatus (trade name: “IMAGE CLARITY METER” manufactured by SUGA TEST INSTRUMENT CO., LTD.) was used to measure a clarity on the top coated surface. A white topcoat paint (“AMILAC WHITE ”) was applied to a film thickness of 35 μm on the coated metal plates obtained in Examples 1 to 5 and Comparative Examples 1 to 2 and cured by heating at 140° C. for 30 minutes. The coated plates thus obtained were measured for a clarity on the top coated surface. The numerals in the table are values falling in a range of 0 to 100 % in terms of an ICM value, and it is shown that the larger the value is, the more excellent the clarity is. The ICM value of 80 or more shows that the clarity is very good.

Weatherability:

A top clear (trade name: “MAGICRON CLEAR #7000” manufactured by Kansai Paint Co., Ltd.) was applied on the coated articles obtained in Examples 1 to 5 and Comparative Examples 1 to 2 and cured by heating. Repeated for the test plates thus obtained was a cycle of storing in a sunshine weather meter (test temperature: 63±3° C., spray period: 12 minutes in 60 minutes and humidity: 50±5%) for 20 hours and dipping in warm water of 40° C. for 2 hours. After finishing each cycle, crosscuts were put on the coated plates, and the peeling property with a cellophane adhesive tape was observed to evaluate the adhesive property. The case where peeling was caused in a wide range in the circumference of the crosscuts on the coated films was marked with ×, and the test time (unit: hour) spent until peeling reached the state of × was determined.

1-9. (canceled)

10. A method for manufacturing a car body, which comprises:
cutting, molding or, if necessary, joining a coated metal plate, comprising a metal plate, and a conductive plastic film or sheet, which is produced by adhering or pressing a preformed conductive plastic film or sheet on at least one surface of the metal plate, wherein the plastic film or sheet has a volume specific resistance value of 10³ Ω·cm or less or a surface resistance value or not more than 100 Ω/□, and thereby forming a shell body for a car body or a car part;
mounting said car part on a main body of a car which has been assembled in advance, to form a shell body;
electrodepositing an anionic or cationic electrodeposition paint comprising a combination of an anionizable or cationizable external crosslinking base resin and curing agent or an internal crosslinking base resin on the resulting shell body; and then
applying a top coat paint on the electrodeposition coating film surface of the shell body.

11. The method according to claim 10, wherein the plastic film or sheet has a thickness in a range of 1 to 100 μm.

12. The method according to claim 10, wherein the plastic film or sheet has a thickness in a range of 3 to 75 μm.

13. The method according to claim 10, wherein the plastic film or sheet contains a conductive substance in the plastic film.

14. The method according to claim 10, wherein the plastic film or sheet has a conductive layer on the surface of the plastic film or sheet.

15. The method according to claim 10, wherein the electrodeposition film is formed from a cationic electrodeposition paint.

16. The method according to claim 15, wherein the cationic electrodeposition paint contains a base resin having a hydroxyl group and an amino group which can be converted to a cation and an aliphatic block polyisocyanate compound.

17. The method according to claim 10, wherein the electrodeposition film has a thickness in a range of about 10 to about 40 μm.

18. The method according to claim 10, wherein the electrodeposition film has a thickness in a range of 10 to 20 μm.

19. The method according to claim 10, wherein the plastic film or sheet is adhered to the metal plate using an adhesive.
